(19) United States
(12) Patent Application Publication
(10) Pub. No.: US 2023/0158513 A1
(43) Pub. Date: May 25, 2023

(54) WESP With Impaction Cleaning, And Method of Cleaning A WESP

(71) Applicant: Durr Systems, Inc., Southfield, MI (US)

(72) Inventors: Jeffrey Rudolph, Suamico, WI (US); Andrew Hassl, Green Bay, WI (US); James Cash, Hackettstown, NJ (US)

(21) Appl. No.: 17/921,216

(22) PCT Filed: Feb. 5, 2021
(86) PCT No.: PCT/US2021/016729

§ 371 Date: Oct. 25, 2022

Related U.S. Application Data
(60) Provisional application No. 63/033,375, filed on Jun. 2, 2020.
(60) Provisional application No. 63/056,940, filed on Jul. 27, 2020.

(51) Int. Cl. B03C 3/78; B03C 3/16; B03C 3/41; B03C 3/49; B03C 3/82; B05B 3/06; B05B 3/14

(52) U.S. Cl. CPC B03C 3/78; B03C 3/16; B03C 3/41; B03C 3/49; B03C 3/82; B05B 3/06; B05B 3/14

(57) ABSTRACT

Method and apparatus for cleaning pollution control equipment, such as particulate removal devices, including wet electrostatic precipitators (WESP). The apparatus may comprise a plenum having a gas inlet for the introduction of process gas into said housing; a gas outlet for discharge of treated process gas from said housing; at least one ionizing electrode; at least one particulate collection electrode; the plenum being in fluid communication with the at least one ionizing electrode and the at least one particulate collection electrode; an upper support frame; a lower support frame connected to the upper support frame and comprising at least one electrode support beam supporting the at least one ionizing electrode; and at least one movable nozzle in the plenum for discharging washing liquid towards the at least one collection electrode to dislodge particulate matter from the at least one collection electrode.

This application claims priority of U.S. Provisional Application Serial No. 63/033,375 filed Jun. 2, 2020 and U.S. Provisional Application Serial No. 63/056,940 filed Jul. 27, 2020, the disclosures of which are incorporated herein by reference in their entireties.

### BACKGROUND

Pollution control equipment, such as wet electrostatic precipitators (WESP) are used to remove dust, acid mist and other particulates from water-saturated air and other gases by electrostatic means. For example, particulates and/or mist laden water-saturated air flows in a region of the precipitator between discharge and collecting electrodes, where the particulates and/or mist is electrically charged by corona emitted from the high voltage discharge electrodes. As the water-saturated gas flows further within the precipitator, the charged particulate matter and/or mist is electrostatically attracted to grounded collecting plates or electrodes where it is collected. The accumulated materials are continuously washed off by both an irrigating film of liquid and periodic flushing to a discharge drain or the like.

Such systems are typically used to remove pollutants from the gas streams exhausting from various industrial sources, such as incinerators, coke ovens, glass furnaces, non-ferrous metallurgical plants, coal-fired generation plants, forest product facilities, food drying plants, wood product manufacturing and petrochemical plants.

In wood product manufacturing in particular, for example, maintenance issues are problematic, particularly due to material build-up on the collectors and on electrodes. Sticky particulates, condensation products, etc. tend to adhere to and accumulate on equipment internals, resulting in poor equipment performance with requires deleterious downtime and unnecessary expense in an effort to remove them. This has been seen in not only in the manufacture of wood products such as panelboard, for example, but also in the biofuel and other markets. Manual intervention is often necessary to adequately clean the equipment internals from the build-up of contaminants, which is highly undesirable. Dirty WESP tubes and electrodes are thus a persistent industry challenge that degrades performance for all WESP styles and designs.

Current industrial practice has been to try to clean the build-up in the WESP with warm water (100-130° F.), caustic solution, or a weak acid solution. In almost all cases the cleaning solution is injected into the WESP through stationary nozzles that cover a broad area to cover all surfaces of the WESP using a minimum number of nozzles to reduce cost. This spreads the mass flux of the liquid across a large area (e.g., 0.05 to 0.25 lbs/(ft²*s)) so there is not much energy hitting the dirty surfaces. Therefore, loose material can be removed, but material that is adhered to the surfaces is not removed. Also, since the spray is typically sprayed at a wide angle (90 degrees), very little of the spray penetrates to a depth of more than a foot in the honeycomb structure.

Accordingly, a method of maintaining the collecting tubes and electrodes in a clean condition with minimal manual cleaning required would be highly beneficial.

It is therefore an object of embodiments disclosed herein to incorporate multiple components in a WESP to provide a much greater impaction energy over areas expected to collect most of the particulate and therefore expected to get the dirtiest.

It is a further object of embodiments disclosed herein to minimize the amount of liquid used to clean a WESP.

### SUMMARY

Problems of the prior art have been addressed by embodiments disclosed herein, which provide a method and apparatus for cleaning pollution control equipment, such as particulate removal devices, including wet electrostatic precipitators, and to provide a particulate removal device including such cleaning apparatus. In certain embodiments, the WESP includes a housing having a chamber, at least one gas inlet in fluid communication with the chamber, a gas outlet spaced from the at least one gas inlet and in fluid communication with the chamber, one or more ionizing electrodes in the housing and one or more collecting electrodes or surfaces in the housing. In some embodiments, the collecting electrodes include a bundle of tubes or cells, which may be cylindrical or hexagonal in cross-section. In some embodiments, bundle of hexagonal in cross-section. In some embodiments, the bundle of tubes forms a honeycomb pattern of hexagonal collecting zones or cells. In certain embodiments, the housing may be placed in fluid communication with a washing liquid source, such as a water source.

In certain embodiments, a particulate removal device, such as a WESP, having movable spray nozzles is provided, wherein the movement of the nozzles is designed so that fluid expelled therefrom impacts all or substantially all of the regions in the WESP where particulate build-up deleterious to the electrostatic performance of the WESP is expected or observed. Efficient and substantially homogeneous cleaning of the collection surfaces is achieved, such as by impact of a mass flux of a washing liquid on each surface element of the particulate collection surfaces over a certain impact time. In some embodiments, the mass flux comprises a spray emitted from the nozzles, which may be a flat fan spray that concentrates a high mass of liquid moving at a moderate velocity (e.g., 30-120 ft/sec) in a small area. In certain embodiments, the particulate removal device is an upflow WESP, and one or more lower movable spray nozzles is provided in a lower plenum upstream of the particulate collection surfaces and is capable of spraying washing liquid towards the collection surfaces to cause impaction cleaning of the same. In some embodiments, one or more upper spray nozzles is provided, which may be movable, positioned downstream of the particulate collection surfaces. The primary function of the one or more upper spray nozzles is to rinse the collection surfaces, and/or to introduce cleaning agents such as sodium hydroxide or sulfuric acid to enhance cleaning.

Embodiments disclosed herein include a particulate removal device for removing particulate from a process gas, the device comprising: a housing comprising a lower plenum having a gas inlet for the introduction of process gas into the housing; a gas outlet for discharge of treated process gas from the housing; at least one ionizing electrode; at least one particulate collection electrode; the lower plenum being in fluid communication with the at least one ionizing electrode and the at least one particulate collection electrode; an upper support frame; a lower support frame connected to the upper support frame and comprising at least one electrode support beam supporting the at least one ionizing electrode; and at least one movable nozzle in the lower plenum for discharging washing liquid towards the at least one collection electrode to dislodge particulate matter from the at least one collection electrode. Preferably the at least one particulate collection electrode is tubular.

In one exemplary embodiment, the at least one movable nozzle is rotatable about a vertical axis. In some aspects the particulate removal device further comprises a support shaft in the lower plenum and having a longitudinal axis, the support shaft supporting one or more rotational arms having at least one nozzle positioned thereon, and wherein the one or more rotational arms is adapted to rotate about the longitudinal axis. In some aspects, there are plurality of nozzles positioned on the one or more rotational arms. In some aspects, one of the plurality of nozzles is angled relative to vertical to provide hydraulic motive energy to the one or more rotational arms, whereby discharging liquid through the angled nozzle causes rotation of the one or more rotational arms.

In another exemplary embodiment, there is an upper nozzle assembly positioned in the housing downstream, in the direction of process gas flow from the inlet to the outlet, of the at least one particulate collection electrode.

In some embodiments, disclosed is a method for cleaning a collection surface of a particulate separation device, in which the collection surface is sprayed with a washing liquid over a cleaning interval, wherein a partial region of the collection surface is sprayed with a minimum quantity of washing liquid for a minimum treatment period, and wherein the washing liquid acts on the partial region with a momentum which varies in time over the minimum treatment period and is effective for dislodging particulate matter adhered to the collection surface.

In some embodiments, the angle of action of the washing liquid relative to a surface normal to the partial region does not remain constant over the minimum treatment period; e.g., it is varied.

In some embodiments, the at least one nozzle is moved or is movable relative to the partial region in such a way that a distance between the at least one nozzle and the partial region varies over the minimum treatment time. In some embodiments, the at least one nozzle is moved or is movable relative to a surface normal to the partial region in such a way that a liquid jet is emitted from the at least one nozzle at an angle varying with the surface normal to the partial region during the minimum treatment period. In some embodiments, the mass flow of the washing liquid is not constant over the minimum treatment period; e.g., it is varied. In some embodiments, the washing liquid is supplied to the one or more nozzles with a varying pressure and/or volume flow. In some embodiments, the outflow from the one or more nozzles varies in time and/or location. In some embodiments, the at least one movable nozzle is mounted on a nozzle device and is movable in at least one degree of freedom with respect to the nozzle device. In some embodiments, the at least one nozzle comprises a fluidic oscillator.

In certain embodiments, a method of removing particulate matter from a contaminated gas supply is disclosed, the method comprising supplying washing liquid to at least one of movable nozzle in a plenum of a particulate removal device comprising one or more ionizing electrodes, one or more particulate collection electrodes or surfaces, at least one inlet for the contaminated air and at least one outlet, the plenum being in fluid communication with the one or more ionizing electrodes and the one or more particulate collection electrodes, and discharging said washing liquid from said nozzle towards said one or more collection electrodes impacting regions of said one or more particulate collection electrodes with said washing fluid emitted from said at least one or more movable nozzles to dislodge particulate from said particulate collection electrodes to clean the same. In some embodiments, the plurality of movable nozzles is upstream, in the direct of gas flow from the inlet to the outlet during operation of said particulate removal device. A source of high voltage for charging the one or more ionizing electrodes may be provided.

In certain embodiments, there are a plurality of electrode support beams and a plurality of ionizing electrodes each having a free end and a supported end supported on one of the plurality of electrode support beams, wherein the free end is downstream, in the direction of process gas flow from the gas inlet to the gas outlet during operation of the device, of the supported end.

In certain embodiments, the particulate removal device is an up-flow WESP, where gas is introduced below the one or more ionizing electrodes and flows vertically upwardly in the device.

In certain embodiments, the device is compartmentalized, or modularized, wherein there are two or more units 100 in a single particulate removal device such as a WESP. In certain embodiments, the WESP has three or more modules. In some embodiments, one of the plurality of modules can be isolated from the others, taken offline and subjected to a cleaning cycle, while the remaining module or modules continue to operate to remove particulate from the process gas stream.

### BRIEF DESCRIPTION OF THE DRAWINGS

The embodiments disclosed herein may take form in various components and arrangements of components, and in various process operations and arrangements of process operations. The drawings are only for purposes of illustrating preferred embodiments and are not to be construed as limiting. This disclosure includes the following drawings.

FIG. 1 is a perspective view of an exemplary particulate removal apparatus in accordance with certain embodiments;

FIG. 2 is an internal view of an upper region of a particulate removal apparatus in accordance with certain embodiments;

FIG. 3 is another internal view of an upper region of a particulate removal apparatus in accordance with certain embodiments;

FIG. 4 is an internal view of a lower region of a particulate removal apparatus in accordance with certain embodiments;

FIG. 5 is another internal view of a lower region of a particulate removal apparatus in accordance with certain embodiments;

FIG. 5A is a perspective view of an outer hub in accordance with certain embodiments;

FIG. 5B is a perspective view of an inner hub in accordance with certain embodiments;

FIG. 5C is a perspective view of a rotational arm of a movable nozzle assembly in accordance with certain embodiments;

FIG. 5D is a view, in partial cross-section, of a rotational arm of a movable nozzle assembly in accordance with certain embodiments;

FIG. 6A is a perspective view of a lower plenum region of a particulate removal apparatus in accordance with certain embodiments;

FIG. 6B is a front view of the linkage assembly shown in FIG. 6B in accordance with certain embodiments;

FIG. 7 is a perspective view showing a preferred fan spray pattern for a movable nozzle assembly in accordance with certain embodiments;

FIG. 8 is a schematic diagram of a deflector bar in accordance with certain embodiments;

FIG. 9 is a schematic view of a surface of a deflector bar in accordance with certain embodiments;

FIG. 10A is a top view of a moveable nozzle assembly in accordance with certain embodiments;

FIG. 10B is a front view of a moveable nozzle assembly in accordance with certain embodiments;

FIG. 10C is an enlarged view of Detail A from FIG. 10A;

FIG. 10D is a front view of a pivot arm of a moveable nozzle assembly at rest in accordance with certain embodiments;

FIG. 10E is a front view of a pivot arm of a moveable nozzle assembly in motion in accordance with certain embodiments;

FIG. 11A is another front view of a moveable nozzle assembly in accordance with certain embodiments;

FIG. 11B is an enlarged view of a region of the moveable nozzle assembly of FIG. 11A showing a moveable sleeve in a first position;

FIG. 11C is an enlarged view of a region of the moveable nozzle assembly of FIG. 11A showing a moveable sleeve in a second position;

FIG. 12 is a schematic view showing a working principle of cleaning surfaces by impaction in accordance with certain embodiments;

FIG. 13 is a schematic diagram of an assembly including a hydraulic pulse generator for introducing washing liquid into nozzles in accordance with certain embodiments;

FIG. 14 is a schematic diagram of a fluidic oscillator in accordance with certain embodiments;

FIG. 15A is a schematic diagram of a particulate removal device showing the use of fresh water to flush in accordance with certain embodiments;

FIG. 15B is a schematic diagram of a particulate removal device showing the use of recirculating water to flush in accordance with certain embodiments; and

FIG. 16 is an internal perspective view of an exemplary particulate removal apparatus in accordance with certain embodiments.

### DETAILED DESCRIPTION

A more complete understanding of the components, processes and apparatuses disclosed herein can be obtained by reference to the accompanying drawing. The figures are merely schematic representations based on convenience and the ease of demonstrating the present disclosure, and is, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawing, and are not intended to define or limit the scope of the disclosure. In the drawing and the following description below, it is to be understood that like numeric designations refer to components of like function.

The singular forms “a,” “an,” and “the” include plural referents unless the context clearly dictates otherwise.

As used in the specification, various devices and parts may be described as “comprising” other components. The terms “comprise (s),” “include (s),” “having, “ “has,” “can,” “contain (s),” and variants thereof, as used herein, are intended to be openended transitional phrases, terms, or words that do not preclude the possibility of additional components.

All ranges disclosed herein are inclusive of the recited endpoint and independently combinable (for example, the range of “from 2 inches to 10 inches” is inclusive of the endpoints, 2 inches and 10 inches, and all the intermediate values).

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. The modifier “about” should also be considered as disclosing the range defined by the absolute values of the two endpoints. For example, the expression “from about 2 to about 4” also discloses the range “from 2 to 4.”

It should be noted that many of the terms used herein are relative terms. For example, the terms “upper” and “lower” are relative to each other in location, i.e. an upper component is located at a higher elevation than a lower component, and should not be construed as requiring a particular orientation or location of the structure. As a further example, the terms “interior”, “exterior”, “inward”, and “outward” are relative to a center, and should not be construed as requiring a particular orientation or location of the structure.

The terms “top” and “bottom” are relative to an absolute reference, i.e. the surface of the earth. Put another way, a top location is always located at a higher elevation than a bottom location, toward the surface of the earth.

The terms “horizontal” and “vertical” are used to indicate direction relative to an absolute reference, i.e. ground level. However, these terms should not be construed to require structures to be absolutely parallel or absolutely perpendicular to each other.

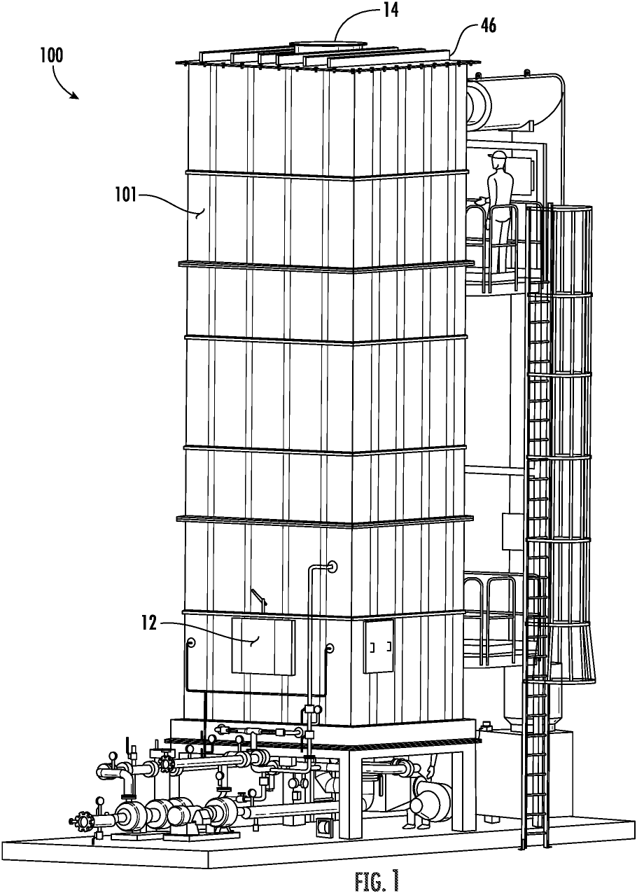

FIG. 1 illustrates exemplary apparatus 100 for removing particulate matter from a gas stream containing particulate matter, and may include a mist-generating member that mixes a gas stream entering the apparatus with liquid droplets, one or more ionizing electrodes that electrically charge the particulate matter and the liquid droplets; one or more collection surfaces such as one or more collection electrodes or tubes that attract and remove electrically-charged particulate matter and intermixed liquid droplets from the gas stream; a source of washing liquid; and one or more movable nozzles configured to be in fluid communication with the source of washing liquid. In certain embodiments, the one or more collection surfaces includes one or more elongated tubes or cells. In some embodiments, the tubes or cells may be hexagonal in cross-section. Other geometric shapes of the tubes or cells may be suitable, including tubes or cells of circular cross-section, square cross-section, rectangular cross-section, heptagonal cross-section, octagonal cross-section, etc. In some embodiments, the unit 100 has a lower inlet 12 and an upper outlet or exhaust 14 spaced from the lower inlet 12. The lower inlet 12 may be in fluid communication with suitable ducting or the like to direct process gas in a generally upward flow to be treated by the unit 100 towards collection surfaces that in the embodiment shown include an array of a plurality of cells. In certain embodiments, the array of cells may be formed by coupling individual plates or walls in the desired shape such as by welding. Adjacent cells share common walls.

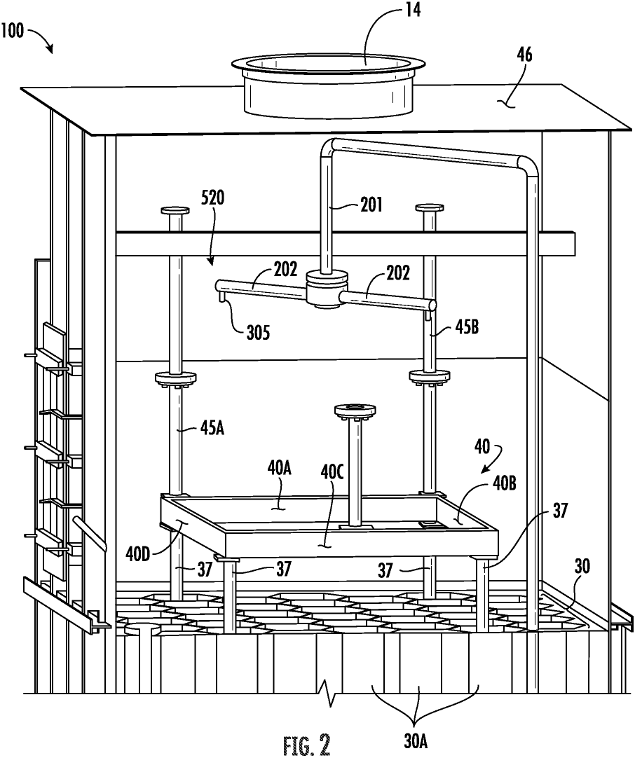

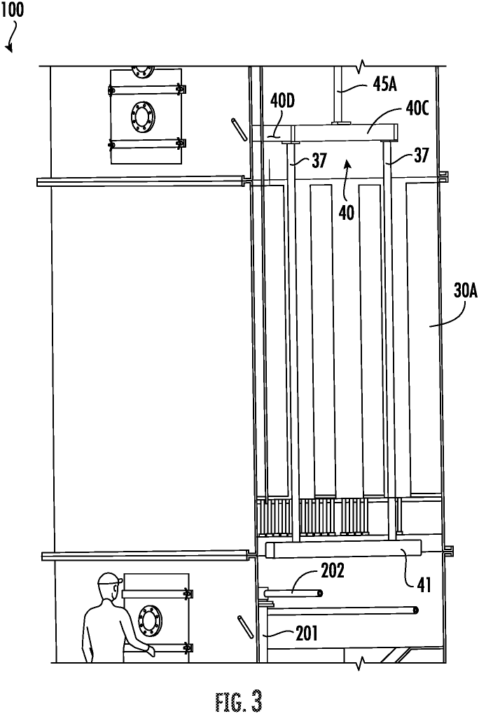

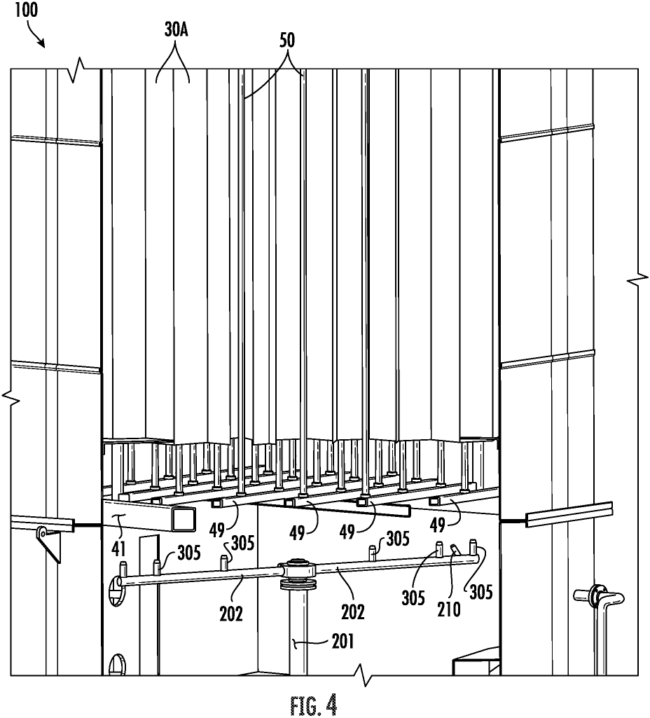

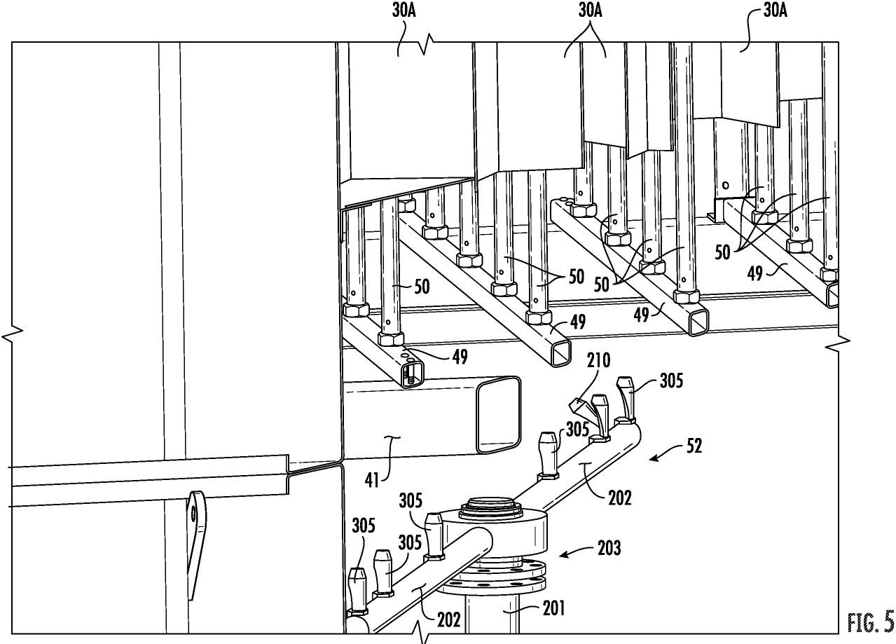

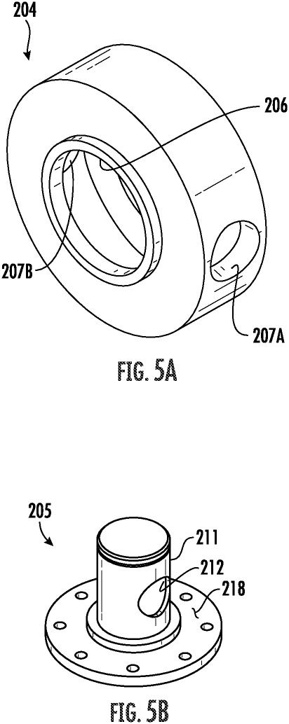

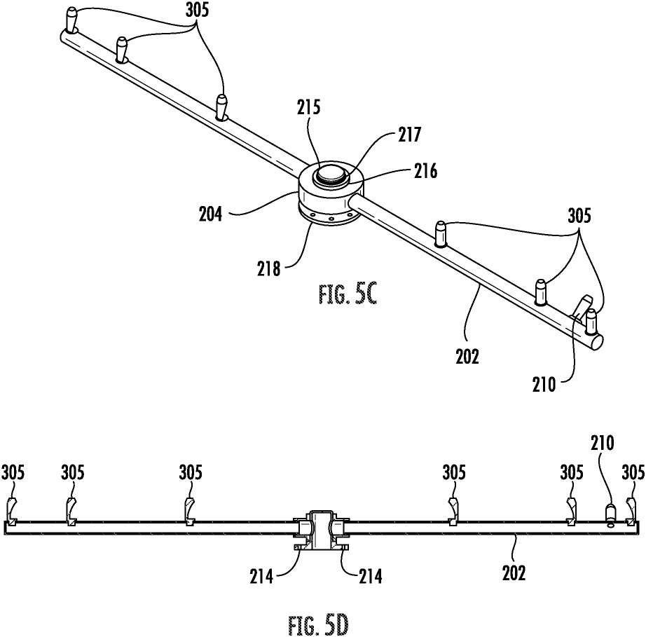

In certain embodiments, an upper or downstream (in the direction of process gas flow from the inlet 12 to the exhaust 14) high voltage frame 40 (FIGS. 2, 3) and a lower or upstream (in the direction of process gas flow from the inlet 12 to the exhaust 14) high voltage frame 41 (FIGS. 4, 5) are suspended from the roof or top wall 46 of the unit 100 with suitable supports including one or more support rods (three shown as 45A, 45B and 45C). In certain embodiments, the upper high voltage frame 40 may include four connected support members 40A, 40B, 40C, 40D that form rectangular upper high voltage frame 40 as shown. The top wall 46 of the unit 100 may be electrically insulated from the support rods 45A, 45B, 45C with respective insulators, which may be housed in respective insulator compartments. In various embodiments, the lower high voltage frame 41 may be supported from the top wall 46 such as via top wall-mounted insulators, or may be supported from side wall-mounted insulators. In some embodiments, the lower high voltage frame 41 and associated supports are not needed and are eliminated. In some embodiments, the upper high voltage frame 40 and associated supports may be eliminated, in which case the lower high voltage frame 41 may be supported from the one or more side walls or the top wall 46 (with suitable insulators).

In some embodiments, where the lower high voltage frame 41 is supported from the upper high voltage frame 40, it may be so supported by one or more support electrodes 37, preferably four, and supports a plurality of rigid electrode support beams 49, which in turn support electrodes or masts 50. In certain embodiments, the rigid electrode support beams 49 are spaced and positioned in a parallel horizontal array, each respectively supporting a plurality of masts 50. Each of the plurality of masts 50 may be generally elongated and rod-shaped and extends upwardly into a respective cell 30A, and is preferably positioned in the center of each cell 30A and is coaxial therewith. Since in this embodiment the masts 50 are supported from the bottom by the plurality of rigid electrode support beams 49, their free ends are downstream, in the direction of process gas flow form the inlet to the outlet, of their supported ends. Preferably the masts 50 are relatively short (e.g., less than 12 feet long, e.g., 10-12 feet long) to minimize deflection. To further minimize deflection, the walls of the masts 50 may be thicker than conventional, e.g., 0.083 inches thick. Further still, cross-bracing may be used to prevent sway of the support structure, e.g., insulated rods or struts connecting the upper high voltage frame 40 and/or lower high voltage frame 41 to a wall of the WESP. In certain embodiments, the volume of each cell 30A defined by its outer wall or walls is empty except for a mast 50. As can be seen in FIG. 5, in some embodiments each of the masts 50 is attached to a rigid electrode support beam 49 with a single bolt or other fastener, and each mast 50 can be pre-aligned prior to assembly into the unit 100. In some embodiments, suitable position adjusters can be provided on the masts 50 or support beams 49 to properly position them in the unit 100.

By supporting the masts 50 from the bottom rather than the top, cleaning of the collecting surfaces is not inhibited, and better access to the unit for maintenance is provided because there are minimal high voltage members above the array 30 of cells 30A. The masts 50, when positioned within each cell 30A and connected to a high voltage source, maintain the array 30 of cells 30A at a desired voltage. In certain embodiments, the electrical potential difference between the masts 50 and the collection surfaces is sufficient to cause current flow by corona discharge, which causes charging of the particulate entrained in the process stream.

In other embodiments, the lower high voltage frame 41 may be supported from top wall mounted insulators, or may be supported from electrical insulators mounted in insulator compartments on the side walls of the WESP, below the at least one collection electrode.

As seen in FIGS. 4 and 5, in certain embodiments, a nozzle movement assembly 52 is provided upstream of the cells 30A in the direction of process gas flow through the unit 100 to optimize the ability of washing liquid to dislodge particulate matter in the of the particulate removal apparatus 100 to carry out impaction cleaning. Preferably the movement of the system may be actuated or adjusted such that the washing liquid contacts a given area for sufficient time such that the energy of the washing liquid can accomplish the cleaning action desired. Contact times desired would typically be in the range of 250-1,000 milliseconds.

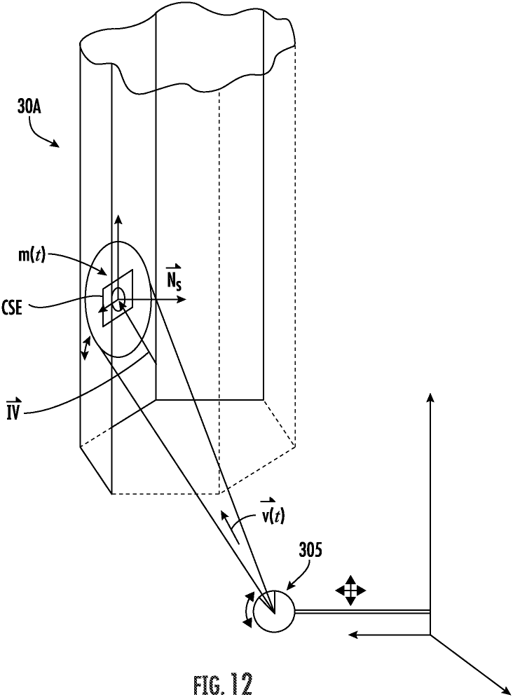

FIG. 12 illustrates a working principle of the impaction that may be achieved with the movable nozzle assembly. A cleaned surface element (CSE) of cell 30A is shown being impacted by impact vector IV. Insome embodiments, the vector/impact angle of the washing fluid with respect to the surface normal (Nₛ vector) to the surface element to be cleaned may be varied. In addition or alternatively, in some embodiments the impulse of the impacting washing fluid may be varied by varying the mass flux and/or the spray velocity and/or the spraying radius.

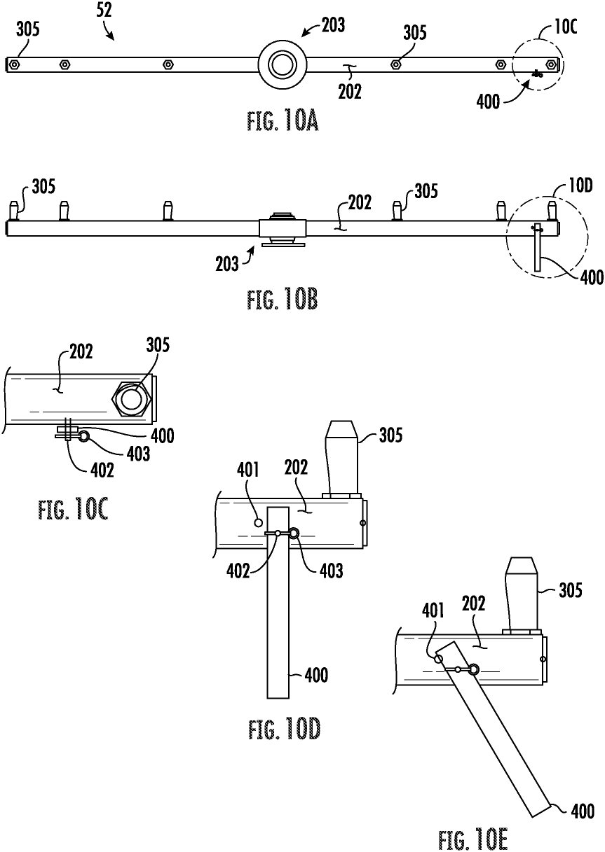

In some embodiments the movement of the movement assembly 52 may be adjusted manually. In other embodiments, an automatic control scheme may be used, such as an actuator which may be selected from a hydraulic actuator, a pneumatic actuator, an electro-static actuator, an electro-magnetic actuator, a piezoelectric actuator, an electro-mechanic actuator, an electric motor, and other actuators being capable of a remote activation. In some embodiments, the actuator may be a battery operated sealed electric motor attached to the nozzle that receives a signal to rotate the nozzle to adjust the nozzle speed. Such a signal may be transmitted wirelessly. In other embodiments, a mechanical method such as a pivot arm or a spring loaded moving sleeve using the centrifugal force of the spray system to partially block the hydraulic energy and therefore self-regulate the rotational speed may be used. For example, as shown in FIGS. 10A, 10B, 10C, 10D and 10E, a mechanical pivot arm 400 may be used to control the hydraulic energy in the movement assembly 52, such as by blocking (partially or completely) an orifice 401 (FIG. 10D) formed in the elongated rotational arm 202. In certain embodiments, the pivot arm 400 is pivotally coupled to the elongated rotational arm 202, such as with a bar 402 coupled to the arm 202 such as by welding (FIGS. 10C, 10D and 10E). The pivot arm 400 may have an aperture (not shown) that receives the bar 402, and is prevented from releasing from the bar with a fastener 403, e.g., a cotter pin. When the movement assembly 52 is at rest (FIG. 10D), the pivot arm 400 rests vertically and does not block the orifice 401; that is the orifice 401 is open to the ambient. When the movement assembly is in motion (FIG. 10E), the resulting centrifugal force causes the pivot arm 400 to swing away from the resting position shown in FIG. 10D, causing a region of the pivot arm 400 to partially block the orifice 401, thereby partially deflecting fluid exiting the orifice 401. This, in turn, controls the speed of the movement assembly 52.

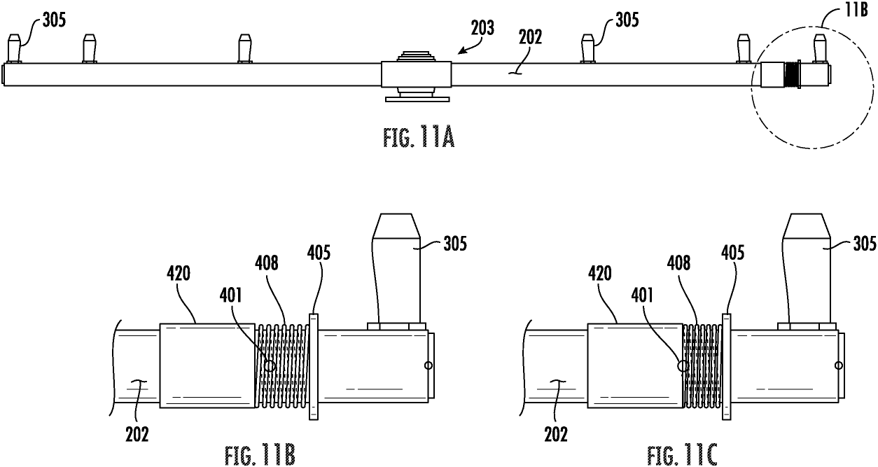

FIGS. 11A, 11B and 11C show yet a further embodiment of controlling the rotational speed of the movement assembly 52. In this embodiment, there is also an orifice 401 (FIGS. 11B and 11C) formed in the elongated rotational arm 202. A sleeve 420 having an inner diameter greater than the outer diameter of the arm 202 is positioned axially on the arm 202 as best seen in FIG. 11B, and is free to translate or slide axially on the arm 202. A stop 405, such as a metal plate 406 coupled to the arm 202 such as by welding, positioned to restrict the extend of travel of the sleeve 420 on The stop 405 also acts as a seat for one end of the arm 202. biasing member or spring 408. The opposite end of biasing member 408 abuts against the sleeve 420. When, the movement assembly 52 is at rest as shown in FIG. 11B, the orifice 401 is not blocked by the sleeve 420. When the movement assembly 52 is in motion (FIG. 11C), the resulting centrifugal force causes the sleeve 420 to slide axially on the arm 202, compress the biasing member 408, and partially blocking the orifice 401, thereby partially deflecting fluid exiting the orifice 401. This, in turn, controls the speed of the movement assembly 52.

In some embodiments, the nozzle movement assembly 52 is designed for operation in a particulate laden environment, without fouling of the bearings or other components of the movement system. In certain embodiments, large clearances in the movement assembly 52 are designed to allow for this. These clearances take advantage of the fact that minor leakage of the cleaning liquid is not an issue in the design. The nozzle movement assembly 52 also should be capable of operation within a temperature range of about 40 to 200° F.

In certain embodiments, the nozzle movement assembly 52 includes a support shaft 201 and one or more elongated rotational arms 202 supported by the support shaft 201. Suitable bearings are provided so that the elongated rotational arm 202 can rotate about central hub 203 of the support shaft 201. As seen in FIGS. 5A and 5B, in the embodiment shown, the central hub 203 includes an outer hub 204 and an inner hub 205. The outer hub 204 may be generally cylindrical, and include a central aperture 206 configured to receive the inner hub 205. The outer hub 204 includes two opposite through-holes 207A, 207B in its side wall 208 as shown, for receiving the elongated rotational arm 202. The inner hub 205 includes a lower disk-shaped flange 218 and a cylindrical member 211 extending upwardly from the flange 218. The cylindrical member is configured to be received in the central aperture 206 of the outer hub 204, and includes opposite through-holes 212 (only one shown) in its side wall as shown, for receiving the elongated arm 202. One or more thrust washers 215, hub bushings 216 and gaskets may be provided, and a retainer ring 217 may be used to assemble the central hub 203 (FIG. 5). In certain embodiments, flat seals 214 (e.g., ultra-high molecule weight plastic or TEFLON seals) (FIG. 5D) may be provided between the inner hub 205 and outer hub 204 as shown, although fluid leakage between the inner hub 205 and outer hub 204 may be tolerated. Because the seals are over a relatively large surface area, fouling by small particulates does not inhibit the hub movement. The seals 214 allow the outer hub 204 to rotate freely.

Accordingly, in certain embodiments, the bearings may be designed with loose tolerances to allow movement in a dirty environment, minimizing friction losses and taking advantage of the fact that leaks through bearing seals are tolerated and not an issue to the operation of the nozzle movement assembly 52.

In certain embodiments, one or more spray nozzles 305 are provided on each of the rotational arms 202 such that spray discharged from the spray nozzles 305 impacts the cells 30A or collecting surfaces at an impaction angle. Preferably substantially all surfaces of the collection electrode below the maximum height that can be reached by the washing liquid discharged from the spray nozzle(s) 305 (based on the angle the washing liquid is discharged from the nozzle(s) are directly impacted by the washing liquid. In certain embodiments, this angle is between about 12^{a} and about 30° relative to vertical. Although A 90° impact angle (i.e. perpendicular) provides the greatest cleaning energy, such an angle is not achievable since spray must be introduced above or below the collecting surfaces or cells 30A. A further consideration on impact angle is the distance into each cell 30A the spray can reach. The shallower (closer to 0°) the angle of impact, the further the spray can reach, but the lower the energy that impacts the cell walls. Accordingly, an angle of 12° to 30° to vertical has been found to be preferred to provide as much energy as possible while retaining impaction energy a reasonable distance into the collection tube array 30. The distance that can be reached into a collection tube is a function of the diameter/width of the collection tube. It is preferable, therefore, to use wider and shorter tubes to maximize the cleanability of the tubes. In one preferred embodiment, 16 inch wide by 10 feet long hexagonal tubes are used with 23° impact angle of the spray system, which allows impaction cleaning approximately 3′ or approximately ⅓ of the way into the tube.

In certain embodiments, the spray nozzles 305 are spaced along the elongated rotational arms 202 to cover all of the collection surfaces in the array 30 as the rotational arms 202 rotate about the longitudinal axis of the support shaft 201. In certain embodiments, both the support shaft 201 and the one or more rotational arms 202 include an internal passage and are in fluid communication with each other, so that washing liquid from a washing liquid source introduced into the support shaft 201 with a driving force such as a pump, can flow from the support shaft 201, to the one or more rotational arms 202, and into each nozzle 305, from which the washing liquid is ultimately discharged. Preferably two rotational arms 202 extend coaxially radially outwardly from the hub 203 on each nozzle movement assembly 52, and the energy of the cleaning sprays are balanced opposite each other on the two rotational arms 202.

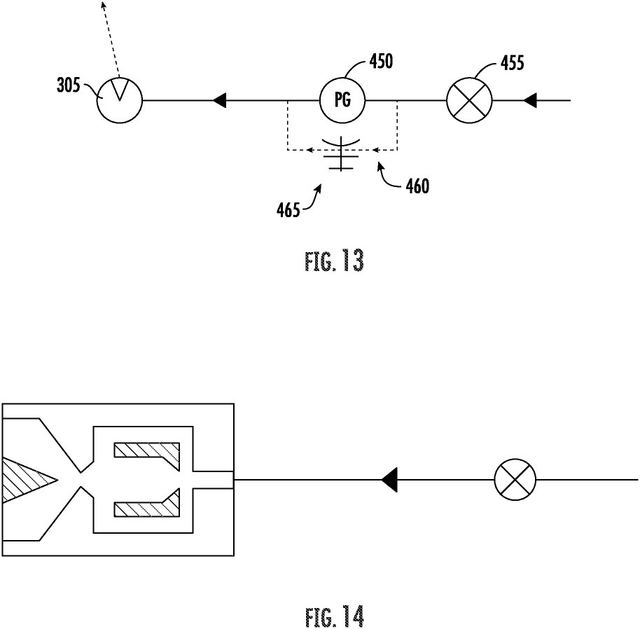

In various embodiments, a hydraulic pulse generator 450 (FIG. 13) may be used upstream of the nozzle 305 to aid in impaction. For example, liquid pump 455 may introduce washing fluid to the pulse generator 450, which causes the fluid to pulse as it flows to the nozzle 305. In some embodiments, the pulse generator 450 may be partially bypassed via bypass line 460 to generate an oscillating liquid pressure with a positive base pressure. The bypass may have a controllable orifice 465 to vary the base line pressure manually, it may be varied in a stochastic automated manner.

In some embodiments as shown in FIG. 14, a fluidic oscillator may be used as or as part of the nozzle 305. Fluidic oscillators typically have no moving parts and spray fluid from side-to-side, generating alternate bursts of fluid.

In some embodiments, rotation of the nozzle movement assembly 52, and of the rotational arms 202 in particular, may be effectuated by positioning one or more angled nozzles 210 on one or more of the rotational arms 202, so that hydraulic energy is used to drive the rotation of the rotational arms 202. Preferably the angled nozzle 210 is positioned at or near the free end of a rotational arm 202, and is positioned at an angle of 35 to 65 degrees relative to vertical. In some embodiments, there are plurality of spray nozzles 305 that are positioned at the same angle relative to vertical (e.g., 0°), and a single angled nozzle 210 that is positioned at the aforementioned angle of 35 to 65 degrees, and therefore is also angled with respect to the plurality of spray nozzles 305. Discharging washing liquid through the one or more angled nozzles 210 causes rotation of the rotational arm 202. In certain embodiments, the angle of the one or more angled nozzles 210 may be adjustable, so as to adjust the speed of rotation of the rotational arms 202. In embodiments where a spray nozzle 305 is threaded onto the rotational arm 202, the adjustment can be made by loosening or tightening the spray nozzle 305 via relative rotation of the nozzle and the rotational arm 202. Rotational speeds up to about 10 rpm are suitable. Higher speeds could be used, but do not offer any advantage and require more energy to achieve. A fluid pressure range of about 40-100 psig is suitable to achieve the objectives discussed herein.

In certain embodiments, more than one such nozzle movement assembly 52 can be positioned upstream of the cells 30A, as needed, so as to ensure spray coverage of a module effective to clean all desired surfaces.

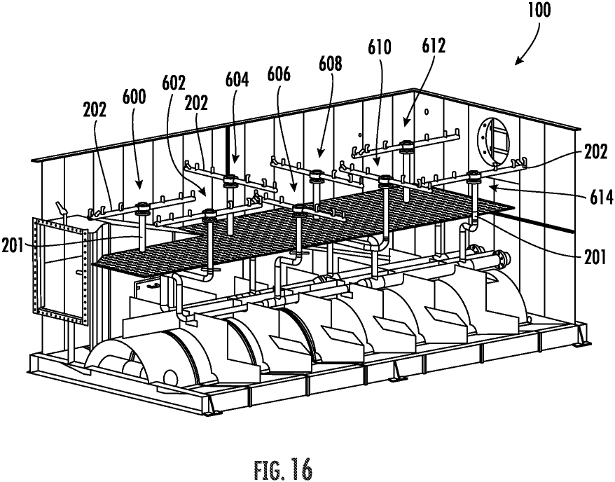

In certain embodiments, multiple nozzle assemblies may be installed at different elevations (relative to horizonal) to allow for an overlapping spray pattern for improved cleaning without the assemblies potentially interfering with each other. FIG. 16 illustrates such an embodiment. Where multiple rows of nozzle assemblies are present, preferably the nozzle assemblies that are diagonally positioned from each other are at the same elevation. For example, in the embodiment shown in FIG. 16, nozzle assembly 600 is at a first, lower elevation, while nozzle assembly 602 is at a second, higher elevation relative to nozzle 600; nozzle assembly 604 is at a high elevation, preferably the same higher elevation as the higher elevation of nozzle assembly 602. Similarly, nozzle assembly 606 is at a low elevation, preferably the same lower elevation as nozzle assembly 600. This pattern continues with assemblies 608, 610, 612 and 614, so that in the embodiment shown, there are two rows of four nozzle assemblies, one row having an elevational arrangement of high-low-high-low nozzle assemblies (as viewed from left to right in the Figure), and the other a corresponding elevational arrangement of low-high-low-high nozzle assemblies (as viewed from left to right in the Figure). In this way, an overlapping spray pattern is achieved while avoiding physical contact or interference between adjacent nozzle assemblies as they rotate or otherwise move, since the rotational arms 202 of each assembly are at different elevations.

In certain embodiments the support shaft 201 may be angled up to 15° from vertical such that assembly 52 is angled up to 15° from horizontal. The purpose of this embodiment would be to allow a different angle of impaction within the tube to improve cleaning. Each of the multiple assemblies 52 may be installed at the same or different angle as necessary to achieve desired cleaning. Suitable angles include from about 3° to about 15°, more preferably from about 5° to about 10°. Thus, angles from about 3°, 4°, 5°, 6°, 7°, 8°, 9°, 10°, 11°, 12°, 13°, 14°, and 15° may be suitable.

In certain embodiments, one or more downstream nozzle assemblies 520 may be provided downstream of (e.g., above) the cells 30A or collection surfaces, as seen in FIG. 2. The one or more downstream nozzle assemblies 520 provided downstream of the cells 30A or collection surfaces may be movable, like the one or more movable nozzle assemblies 52 provided upstream of the cells 30A or collection surfaces. The primary function of the one or more downstream nozzle assemblies 520 is to provide a rinse feature, e.g., to rinse loose material off of components such the collection surfaces, and they also optionally may be used to introduce a cleaning agent such as sodium hydroxide or sulfuric acid. Since unlike the one or more upstream nozzle assemblies 52, impaction cleaning is not their primary function, the speed of movement of the one or more downstream nozzle assemblies 520 is not critical, and angled nozzles need not be provided to create hydraulic motive energy for rotation. Its speed of rotation may be dictated instead by the amount of water flow; the more water flow to the nozzles 520, the faster they rotate. Alternatively, an electric motor can be used to move the one or more downstream nozzle assemblies 520. Similarly, a motor may be used to move the one or more upstream nozzle assemblies 52.

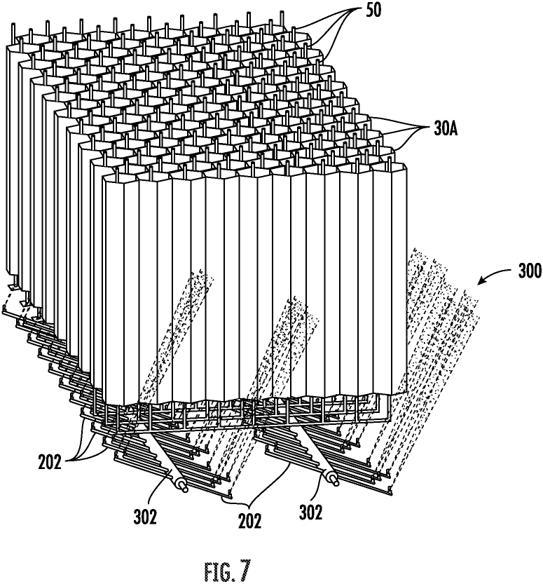

In certain embodiments, it may be desirable to optimize the spray pattern of the washing liquid discharged from the nozzles 305. The use of fan nozzles that emit flat fan sprays 300 that concentrate a high mass of liquid at moderate velocities in a small area may be used, as shown in FIG. 7. In some embodiments, the mass flux may be a 10 -2,000 lbs/(ft²*s) with a velocity range of 30 to 120 feet per second. The lower end of 10 lbs/ (ft²*s) is approximately 50 to 200 times greater than conventionally used. This provides a potential impaction energy flux in the range of 140 to 450,000 (lb_{f}*ft) / (ft²*s). The actual impaction energy flux is affected by a number of variables such as angle of impaction, surface roughness, and properties of any material that is built up on the surface. As discussed previously this high energy flux is achieved by focusing the liquid flow in a small area and requires the nozzles to be moved to adequately clean the majority of the WESP surfaces where buildup occurs. These high impaction energies could also be achieved with low volume high velocity sprays as are commonly used in a standard pressure washer. However, these systems require very small passages to achieve the high velocities necessary and these passages are very prone to fouling in the dirty environment of a WESP. Therefore the high volume, moderate velocity liquid cleaning system described herein, which allows larger flow passages that are much less susceptible to plugging, is preferred. In one preferred embodiment, mass fluxes are 100 to 500 lbs/(ft²*s) with a velocity range of 75 to 95 feet per second. This provides a potential impaction energy flux in the range of approximately 10,000 to 70,000 (lb_{f}*ft) / (ft²*s) .

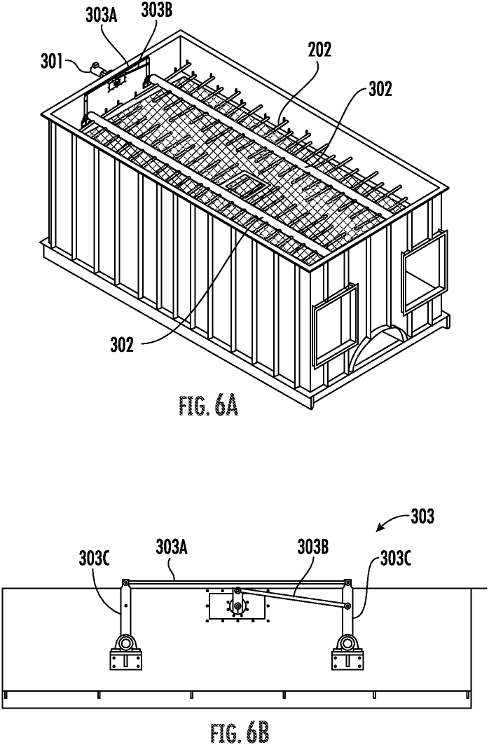

In an alternative embodiment, an electric motor may be used as the driving energy to drive the rotation of the rotational arms 202. Multiple pipes may be used with the spray nozzles inserted along the length of the pipe, as shown in FIG. 6A. The pipes are oscillated together by a single motor 301 with a linkage assembly 303 including a lower header connecting rod 303A and a crank arm connecting rod 303B connected to a pivot arm 304 (FIG. 6B). The oscillating movement moves the nozzles 305 so that they impact the tubes at different angles in different locations, to provide cleaning. This embodiment requires substantially more nozzles to clean the same area as the rotary spinning system embodiment, but keeps the bearing surfaces from being exposed to the process liquid. When motor 301 rotates the assembly, rod 303B will push arm 303C clockwise as viewed in FIG. 6B during the rotation from 0 to 90 degrees. This will rotate shaft 302 clockwise. When rotating from 90 to 270 degrees, the rod 303B will rotate arm 303C and shaft 302 counterclockwise. The rotation will proceed back to clockwise from 270 to 0 degrees. Rod 303A connects the two arms 303C so that they move together.

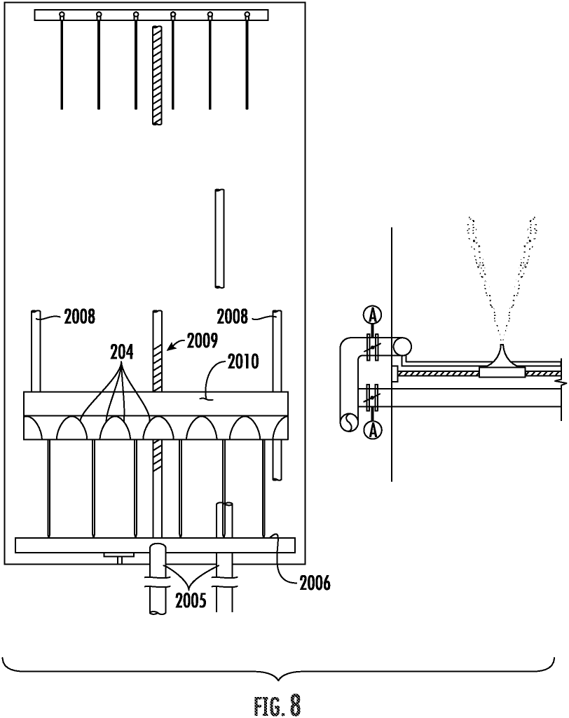

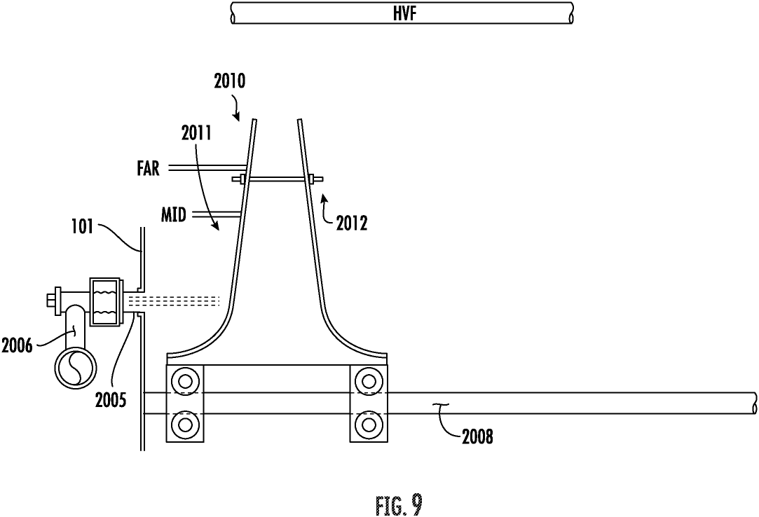

In an alternative embodiment, with reference to FIGS. 8 and 9, one or more spray nozzles 2005 in fluid communication with a manifold 2006 or the like may be mounted on or near the side wall 101 of the WESP housing to spray washing liquid in a solid stream in a roughly horizontal plane. Preferably the nozzles 2005 are located on either side of the WESP in order to be able to clean all collecting surfaces. In certain embodiments, the one or more nozzles 2005 spray a tight column of liquid in open air, and may be smooth bore nozzles which exhibit such a tight column. A deflection bar 2010 may be provided to move horizontally along the bottom of the WESP, such as on one or more rails 2008 in conjunction with a linear drive 2009. The deflection bar may include surfaces 2011 that when impacted by the liquid column emitted from the one or more nozzles 2005, deflect the solid column spray at an angle, such as a 65° to 75° angle, creating a fan spray pattern into the collection tubes for cleaning the same. Thus, in this embodiment, the energy of the water hitting the appropriately configured and dimensioned surfaces 2011 of the deflection bar 2010 form the fan spray. As seen in FIG. 9, an adjuster 2012 may be provided to adjust the angle of the surfaces 2011 where the water column contacts for deflection. Suitable sources of drive energy to move the deflection bar 2010 may be hydraulic, such as by using a portion of the washing liquid supply used for cleaning, or electric, such as with an electric motor and a linear drive. This embodiment has the advantage of using large spray nozzles that are less prone to plugging and facilitate maintaining them while the WESP is operating. The manifold 2006 and a portion of the nozzle bodies may be located outside the WESP housing, e.g., external to side wall 101, further facilitating maintenance thereof.

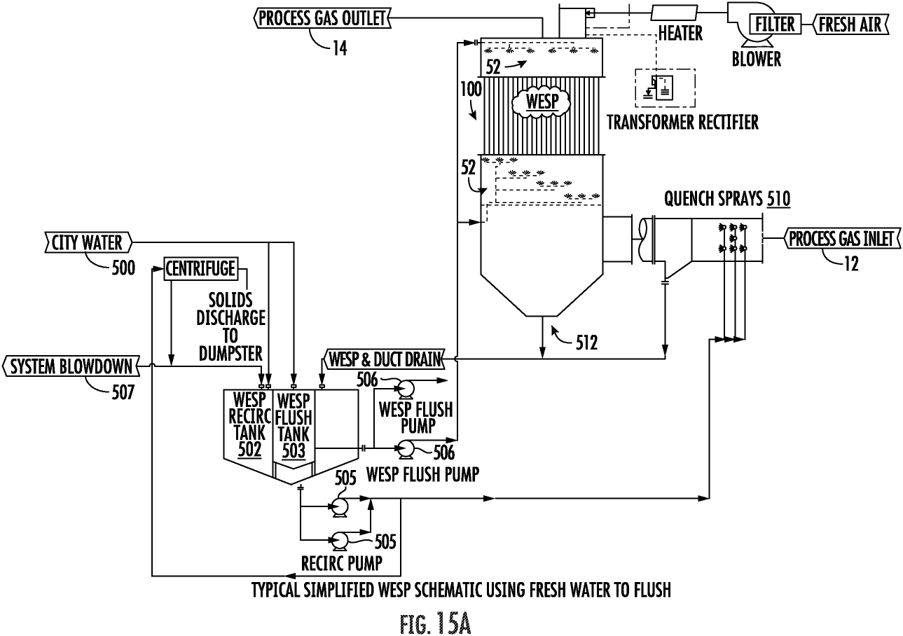

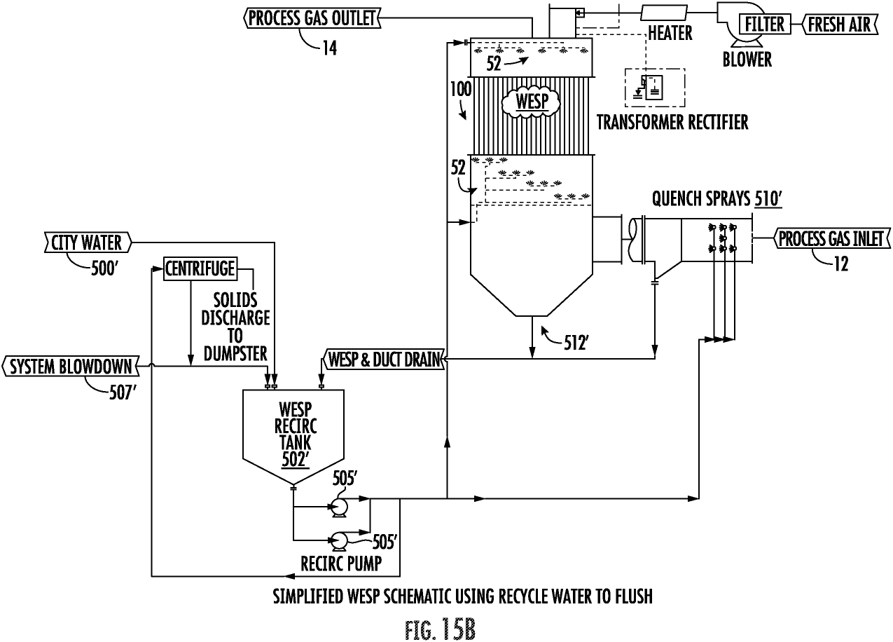

In certain embodiments, recirculating liquid may be used in place of fresh water or other clean liquid. As shown in FIG. 15A, recirculating liquid may be used continuously to quench the process gas to saturation temperature which is required for proper operation of the WESP. The embodiment of FIG. 15A uses fresh water from a suitable source (e.g., city water 500) to supply washing fluid to the upper and/or lower spray nozzles as shown. Thus, a WESP recirculation tank 502 and a suitable driving force such as one or more pumps 505 are provided to supply the quench sprays 510 for quenching the process gas as it is introduced into the WESP, and a flush tank 503 and a suitable driving force such as one or more pumps 506 are provided to supply fresh water to the upper and/or lower spray nozzles. The flush tank 503 can be located inside of the recirculation tank 502 as shown in FIG. 15A to heat the flush water using the heat from the recirculating water, which is typically 10 to 15 F less than the saturated air temperature. In practice this heats the flush water to approximately 40 to 60 F less than the recirculating water. In certain embodiments, the WESP has a fluid drain 512 in fluid communication with the recirculation tank 502 through suitable ductwork or the like. The use of fresh water limits the amount of water that can be used during the flush to less than or equal to the amount of water that is evaporated by saturating the gas and the amount of water that is removed through the system blowdown 507. Otherwise water will accumulate in the system.

In some embodiments such as that shown in FIG. 15B, recirculating liquid also may be used as a source of washing fluid supply. Using this liquid for cleaning collection surfaces allows a much larger volume of liquid to be used for cleaning without impacting the accumulation of water in the system. The recirculating water typically has a substantial amount of solids in it (between 2-4% by weight). Accordingly, the liquid may be filtered or screened to remove larger solids (typically greater than ⅛″). Therefore, as discussed above the spraying components may be designed to function while flowing the particulate laden water. As shown in FIG. 15B, Water from the recirculation tank 502′ is used as the source of washing fluid to the upper and/or lower spray nozzles and to the quench sprays 510′ as shown. A suitable driving force such as one or more pumps 505′ are provided to supply the quench sprays 510′ for quenching the process gas as it is introduced into the WESP, and to supply recirculating water to the upper and/or lower spray nozzles. In certain embodiments, the WESP has a fluid drain 512′ in fluid communication with the recirculation tank 502′ through suitable ductwork or the like. In this case, fresh water from a suitable source (e.g. city water 500′ ) is only used as make-up water as needed to balance the system from evaporation losses and system blowdown 507′.

In certain embodiments, hotter liquid, such as recirculating water, may be used in the spraying system for improved cleaning. Higher temperatures increase the solubility of nearly all solids. By using higher temperature cleaning liquid, the effectiveness of the cleaning can be enhanced substantially. Typical temperature ranges of from 150 to 180° F. are suitable.

In certain embodiments, the cleaning may be performed when the process flow through the WESP module is offline. If the process is online through the WESP during a cleaning cycle, essentially no particulate is being removed because the power must be shut off during a cleaning cycle. Therefore, the cleaning cycle time must be relatively short (<5 minutes) because of regulatory or downstream process requirements. Cleaning the module offline allows the system to take extended time for cleaning while minimizing the downstream impact by maintaining the particular removal of the gas in other WESP modules in parallel with the module being cleaned. The extended offline cleaning can enhance the use of common cleaning chemicals such sodium hydroxide or sulfuric acid by allowing these chemicals time to react with the buildup before being rinsed off, which can greatly improve the removal efficiency. Another benefit of this embodiment is that none of the mist created during the washing cycle is carried downstream of the equipment, since there is no airflow during the cleaning cycle.

If the WESP is an upflow design, another embodiment is to include a rinsing flow from the top of the WESP either during or at the conclusion of the impaction cleaning performed at the bottom of the WESP. This rinsing flow can either be stationary or moving as described for the impaction cleaning sprays. The rinsing sprays provide a method of rinsing off any solids loosened and pushed up in the WESP by the lower impaction sprays.

A final rinse of the WESP with fresh water after the cleaning cycle is finished may be carried out. This final cleaning cycle serves to remove residual solids left when the recirculating water is turned off as well as to flush any residual solids out of the wash piping.

### EXAMPLE

Consider a 3 module upflow WESP system treating 150,000 ACFM of polluted air. Timers in the control system initiate the cleaning cycle for one of the modules. The following steps may be performed.
The module to be cleaned is isolated from the process gas either by closing a damper or other means of stopping the process gas flow to that module.
The process gas flow is forced to flow through the two modules remaining online where it is still cleaned at a modest loss in efficiency because of the higher flow rate.
The power to the electrostatic system is turned off after the flow is stopped.
After the power is turned off, one or more lower (i.e., upstream of the collection surfaces) rotary spin systems is activated, spraying approximately 900 GPM (gallons per minute) of hot recirculating water. The spinners remain on for approximately 30 seconds, rotating at approximately 2 RPM to remove any loose deposits.
A cleaning solution of sodium hydroxide (or other cleaning agent) and water can then be applied through the upper sprays (i.e., downstream of the collection surfaces) for a short period (e.g., 15 to 30 seconds).
One or more lower rotary spin systems is then turned on again, spraying approximately 900 GPM of recirculating water. The spinners remain on for 3 to 5 minutes, rotating at approximately 2 RPM, for primary cleaning.
Once complete, an upper rinse spray, running at 450 GPM of recirculating water, is turned on for 1 to 2 minutes to wash down material dislodged by the primary cleaning cycle.
During this time, 100 GPM of fresh water may be flushed through the lower sprays for 30 to 60 seconds to flush the recirculating water out of the piping.
A final rinse of either fresh water or cleaning solution through the top sprays is carried out to clean the upper spray lance and any residue left by the recirculating water. A flow rate of approximately 100 GPM for 15 to 30 seconds may be used.
A delay of approximately 2 minutes may be employed for excess water to drain before power is turned back on to the electrodes and air flow is reestablished through the module.

What is claimed is:

1. A particulate removal device for removing particulate from a process gas, said device comprising:
a housing comprising a plenum having a gas inlet for the introduction of process gas into said housing; a gas outlet for discharge of treated process gas from said housing; at least one ionizing electrode; at least one tubular particulate collection electrode; said plenum being in fluid communication with said at least one ionizing electrode and said at least one tubular particulate collection electrode; and at least one movable nozzle in said lower plenum configured to discharge washing liquid towards said at least one tubular collection electrode to dislodge particulate matter from said at least one tubular collection electrode.

2. The particulate removal device of claim 1, wherein said at least one movable nozzle is rotatable about a shaft on a vertical axis.

3. The particulate removal device of claim 2, wherein said movable nozzle is mounted on one or more arms mounted to a rotating hub.

4. The particulate removal device of claim 3, wherein said shaft, hub, and arms are hollow and liquid is pumped through said shaft, hub, and arms to said nozzle.

5. The particulate removal device of claim 4, wherein there are plurality of nozzles positioned on said one or more arms.

6. The particulate removal device of claim 5, wherein one of said plurality of nozzles is angled relative to vertical.

7. The particulate removal device of claim 6, wherein discharging liquid through the angled nozzle causes rotation of said one or more arms around said rotating hub.

8. The particulate removal device of claim 7, wherein the speed of rotation is adjusted by rotating the position of said angled nozzle manually.

9. The particulate removal device of claim 7, wherein the speed of rotation is adjusted by rotating the position of said angled nozzle with an actuator.

10. The particulate removal device of claim 5, wherein an orifice on one of the one or more arms is angled relative to vertical.

11. The particulate removal device of claim 10, wherein discharging liquid through the orifice causes rotation of said one or more arms around said rotating hub.

12. The particulate removal device of claim 11, further comprising a movable member movable with respect to said one or more arms to partially block said orifice.

13. The particulate removal device of claim 12, wherein said movable member is pivotable with respect to said one or more arms.

14. The particulate removable device of claim 12, wherein said movable member is axially translatable on one of said one or more arms.

15. The particulate removal device of claim 5, wherein the rotating hub is moved by an actuator.

16. The particulate removal device of claim 1, further comprising one or more rotating support shafts in said lower plenum and having a longitudinal axis, said support shaft supporting one or more arms, wherein said at least one nozzle is positioned on said one or more arms, and wherein said one or more arms is adapted to rotate about said longitudinal axis.

17. The particulate removal device of claim 16, wherein there are plurality of nozzles positioned on said one or more arms.

18. The particulate removal device of claim 17, wherein said longitudinal shaft is rotated by an actuator.

19. The particulate removal device of claim 18, wherein multiple longitudinal shafts are rotated by one electric motor with a linkage assembly.

20. The particulate removal device of claim 19, wherein the longitudinal shaft and arms are hollow and liquid is pumped through the shaft to the nozzles mounted on said arms.

21. The particulate removal device of claim 1, further comprising a downstream nozzle assembly positioned in said housing downstream, in the direction of process gas flow from said inlet to said outlet, of said at least one tubular particulate collection electrode.

22. The particulate removal device of claim 1, wherein said at least one movable nozzle is configured to discharge washing liquid at a velocity of at least 30 feet per second towards said at least one tubular collection electrode and impact said at least one tubular collection electrode at a mass flux of at least 10 lbs/(ft²*s) to dislodge particulate matter from said at least one tubular collection electrode.

23. A method of cleaning a particulate removal device, comprising:
supplying washing liquid to at least one movable nozzle in a plenum of a particulate removal device comprising a housing having a gas inlet for the introduction of process gas into said housing; a gas outlet for discharge of treated process gas from said housing; at least one ionizing electrode; at least one tubular particulate collection electrode; said plenum being in fluid communication with said at least one ionizing electrode and said at least one tubular particulate collection electrode; and discharging said washing liquid from said nozzle towards said at least one tubular particulate collection electrode to dislodge particulate matter from said at least one tubular particulate collection electrode while moving said at least one movable nozzle, such that substantially all surfaces of the collection electrode below the maximum height that can be reached are directly impacted by the washing fluid at an angle of 12° or greater, where 90° is normal to the surface.

24. The method of claim 23, wherein said movement of said at least one nozzle is rotational movement.

25. A particulate removal device for removing particulate from a process gas, said device comprising:
a housing comprising a plenum having a gas inlet for the introduction of process gas into said housing; a gas outlet for discharge of treated process gas from said housing; at least one ionizing electrode; at least one particulate collection electrode; said plenum being in fluid communication with said at least one ionizing electrode and said at least one particulate collection electrode, and a lower high voltage frame positioned below said particulate collection electrode comprises at least one electrode support beam supporting said at least one ionizing electrode.

26. The particulate removal device of claim 25, wherein said housing has a roof, said device further comprising electrical insulators supported from said roof wherein said lower high voltage frame is connected to and supported by said insulators.

27. The particulate removal device of claim 25, further comprising an upper high voltage frame; and wherein said lower high voltage frame is connected to and supported by said upper high voltage support frame.

28. The particulate removal device of claim 25, wherein said housing has side walls, and wherein said lower high voltage frame is supported from electrical insulators mounted in insulator compartments on said side walls, below said at least one collection electrode.

29. A particulate removal device for removing particulate from a process gas, said device comprising:
a housing comprising a plenum having a gas inlet for the introduction of process gas into said housing; a gas outlet for discharge of treated process gas from said housing; at least one ionizing electrode; at least one particulate collection electrode; said plenum being in fluid communication with said at least one ionizing electrode and said at least one particulate collection electrode; and at least one movable nozzle in said lower plenum configured to discharge washing liquid towards said at least one collection electrode at a mass flux of at least 10 lbs/ (ft²*s) and a velocity of at least 30 feet per second towards said at least one collecting electrode to dislodge particulate matter from said at least one collection electrode.

30. The particular removal device of claim 29, where said at least one particulate collection electrode is tubular.

31. The particulate removal device of claim 29, wherein there are a plurality of particulate collection electrodes arranged in an array, and each of the particulate collection electrodes within said plurality are hexagonal in cross-section.
